(19) United States
(12) Patent Application Publication
(10) Pub. No.: US 2020/0149640 A1
(43) Pub. Date: May 14, 2020

(54) Magnetically Operated Multi-Port Valve

(71) Applicant: PicoBrew, Inc., Seattle, WA (US)

(72) Inventors: Avi R. Geiger, Seattle, WA (US); Jonathan Kjell Beardsley, Federal Way, WA (US)

(73) Assignee: PicoBrew, Inc., Seattle, WA (US)

(21) Appl. No.: 16/190,188

(22) Filed: Nov. 14, 2018

(51) Int. Cl. F16K 11/02

(52) U.S. Cl. CPC F16K 11/025

(57) ABSTRACT

A multiport valve may use a magnetic sphere in a fluid flow path to block flow. A magnet external to the fluid flow path may cause the sphere to pull away from the blocked position and may permit flow. The magnet may be moved away from the sphere, causing the sphere to again block the flow. By arranging multiple ports along the path of a magnet, each port may be individually actuated with a single magnet. The magnet's position may be controlled by a motor, allowing for computer controlled selection of a valve to be actuated with a minimum of moving parts and leakage. Each sphere may seal against an o-ring or against a cone, and the magnet may be selected to overcome the pressure forces holding the sphere in the sealed position.

### BACKGROUND

Valves may be used to start and stop flow. Mounting a valve in a manifold may allow fluid, such as gas or liquid, to be dispensed into different outputs.

### SUMMARY

A multiport valve may use a magnetic sphere in a fluid flow path to block flow. A magnet external to the fluid flow path may cause the sphere to pull away from the blocked position and may permit flow. The magnet may be moved away from the sphere, causing the sphere to again block the flow. By arranging multiple ports along the path of a magnet, each port may be individually actuated with a single magnet. The magnet's position may be controlled by a motor, allowing for computer controlled selection of a valve to be actuated with a minimum of moving parts and leakage. Each sphere may seal against an o-ring or against a cone, and the magnet may be selected to overcome the pressure forces holding the sphere in the sealed position.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a rotary valve system.

FIG. 2 is a diagram illustration of an embodiment showing an exploded view of a rotary valve system.

FIG. 3 is a diagram illustration of an embodiment showing a cross-sectional view of a rotary valve system.

FIG. 4 is a diagram illustration of an embodiment showing a linear valve system.

FIG. 5 is a diagram illustration of an embodiment showing a cross-sectional view of a linear valve system.

FIG. 6 is a diagram illustration of an example cross section of a sphere and an O-ring seal.

### DETAILED DESCRIPTION

Magnetically Operated Multi-Port Valve

A multi-port valve may use magnetic spheres to block each port of a valve system. The magnetic spheres may be placed in the flow path, but a magnet located outside the flow path may pull a sphere from its blocked position to allow fluid to pass. The ports may be fed by a manifold, and in many cases, the manifold and ports may be manufactured from two plates.

A multi-port valve system may have a computer-controlled motor that may move the magnet from one port to the next. The computer-controlled motor may position the magnet above a sphere to be opened, and the magnet may cause the sphere to be retracted away from the sealed position, thereby allowing fluid to pass. The magnet may then be passed away from the position, causing the sphere to return to the closed position.

The sphere may be a magnetic material that may be attracted to the magnet. The sphere may rest in an O-ring or cone-shaped opening, and may seal against the O-ring or the cone-shaped opening. The opening may be constructed to trade off between the sealing force and the force to retract the sphere in the presence of a magnet. In a sealed position, any pressure force exerted by the fluid in the system may hold the sphere against the O-ring or cone feature, which may act against the magnetic force used to open the valve.

A contact angle of between 90 and 120 degrees has been found to be an appropriate tradeoff between the various forces, with 100 to 110 degrees to be preferred. Excellent performance has been achieved with 105 to 107 degrees. The contact angle may be achieved against an O-ring or against a cone-shaped feature.

In some cases, the cone-shaped feature may be compliant, such as when manufactured of silicone or other compliant material. In other cases, the cone-shaped feature may be a hard feature that may be polished or otherwise smooth such that the sphere may seat against it for sealing.

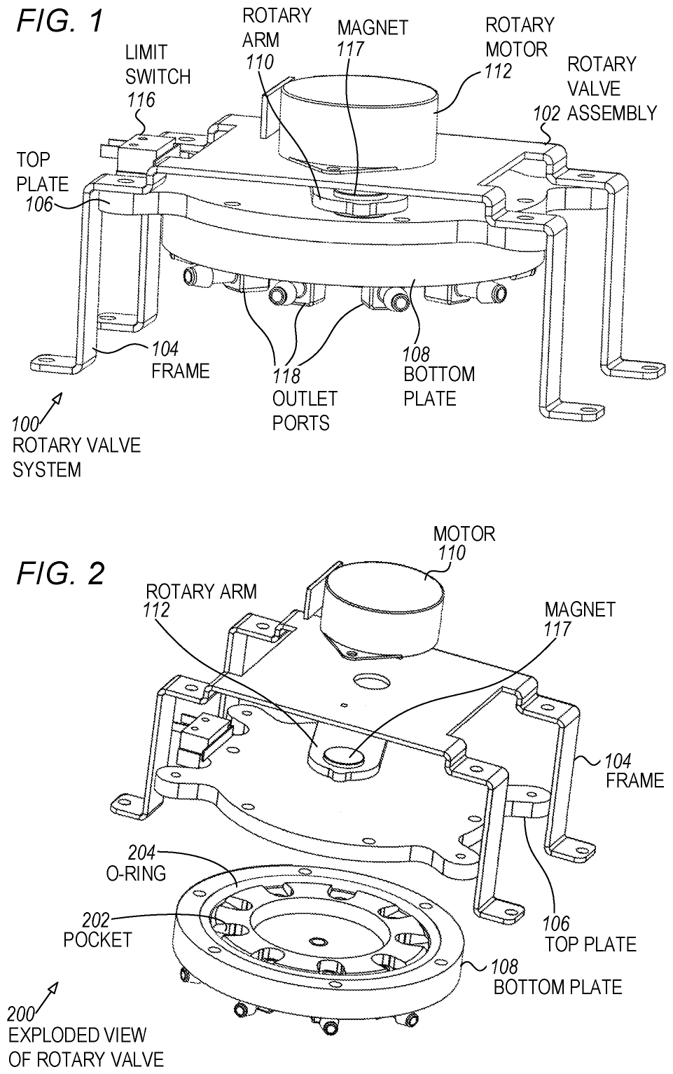

FIG. 1 is a diagram illustration of an embodiment 100 showing a multiport rotary valve system. The rotary valve assembly 102 may have a frame 104, which may support a top plate 106 and bottom plate 108 through which a fluid may pass. A center inlet port, not shown, may supply the fluid, which may pass to several valves and out the outlet ports 118.

The valves may operate by a ferrous sphere seated in a cone or against a compliant material, such as a small O-ring. A magnet 114 may be passed above the sphere, which may cause the sphere to pull away from the seated position and allow fluid to flow. A rotary arm 110 holding the magnet 114 may be rotated by a rotary motor 112. A limit switch 116 may determine a home or other predefined position for the rotary arm 110 so that the rotary motor 112 may calibrate itself.

FIG. 2 is a diagram illustration of an exploded view embodiment 200 of the rotary valve assembly 102. In the exploded view, frame 104 is shown, along with top plate 106 and bottom plate 108. The motor 110, rotary arm 112, and magnet 114 may also be shown.

The valve pocket 202 may be shown along with a sealing O-ring 204. The sealing O-ring 204 may seal the top plate 106 to the bottom plate 108, when the two plates may be held together by screws.

The valve pocket 202 may be where a ferrous sphere may be located. When the magnet 114 may be passed over the top plate 106 in the area of the sphere, the sphere may be drawn away from the sealed position, thereby opening the valve. As the magnet 114 may be rotated away from the pocket 202, the sphere may attempt to follow the magnet 114, but the walls of the pocket 202 may prevent the sphere from moving further. As the magnet moves further away, the magnetic attraction may become less, and the sphere may fall back into the valve pocket 202, thereby re-sealing the valve.

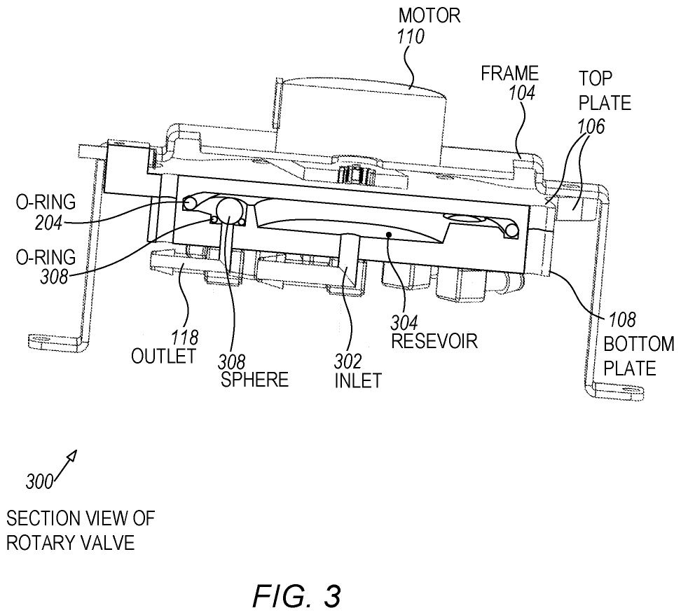

FIG. 3 is a diagram illustration of a section view embodiment 300 of the rotary valve assembly 102. In the section view, frame 104 is shown, along with top plate 106 and bottom plate 108. The motor 110 is also shown, along with O-ring 204 which may seal between the top plate 106 and bottom plate 108.

Fluid, be it a liquid or gas, may flow from an inlet 302 into a reservoir 304, which may feed each of the various valve pockets. A sphere 306 may seal against an O-ring 308. When a magnet pulls the sphere 306 way from the O-ring 308, fluid may flow out the outlet 118.

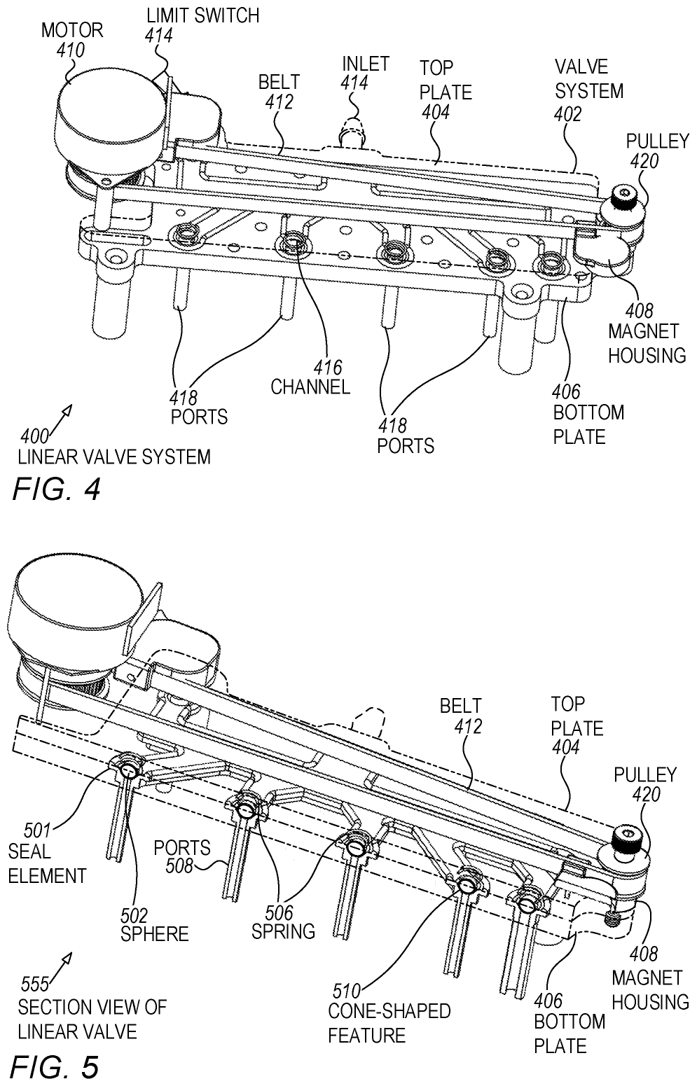

FIG. 4 is a diagram illustration of an embodiment 400 showing a linear valve system 402. The linear valve system 402 may be a different configuration of a valve system than the rotary valve system 102, in that the magnetically-operated valves may be arranged in a line, as opposed to a circle. The principle of operation of the valves may remain that a magnet outside of the valve may pull a ferrous sphere away from a seated position. The sphere may be located in the fluid path, yet the magnet may be outside of the fluid path.

The valve system 402 may be made up of a top plate 404 and bottom plate 406, which may be held together with fasteners or some other assembly mechanism. The top plate 404 may be illustrated in a transparent rendering, thereby allowing some of the internal features to be viewed.

A motor 410 may drive a magnet housing 408 using a belt 412 and pulley 420. A limit switch 414 may be used to calibrate the position of the magnet housing 408. The magnet housing 408 may be passed over various valve pockets, thereby actuating individual valves.

Fluid may flow through an inlet 414 and along various channels, such as channel 416. When a valve may be actuated, fluid may leave the valve assembly through various ports 418.

FIG. 5 is a diagram illustration of a section cut embodiment 500 showing the linear valve system 402. The top plate 404 and bottom plate 406 may be shown, along with a magnet housing 408 attached to a belt 412 and pulley 420.

A sphere 502 may be shown in a seated location in a cone-shaped feature 510. A sealing element 504 may seal a channel between the top plate 404 and bottom plate 406. The sphere 502 may be held in place by a spring 506, thereby sealing fluid flow from passing through the port 508.

The port 508, cone-shaped feature 510, and the sealing element 504 may be one continuous piece. In some embodiments, such a piece may be molded silicone or other compliant material.

The sphere 502 may be held in place with a spring 506. The spring 506 may assist in sealing the sphere 502 against a cone-shaped feature 510, yet may be sized with a limited amount of force such that a magnet may be able to retract the sphere away from the cone-shaped feature 510.

The downward forces acting on the sphere 502 may include pressure applied by the fluid acting to press the sphere against the cone-shaped feature, as well as forces applied by the spring 506. A magnet located outside of the top plate 404 may be strong enough to overcome the downward forces and thereby cause the sphere to retract away from the cone-shaped feature 510.

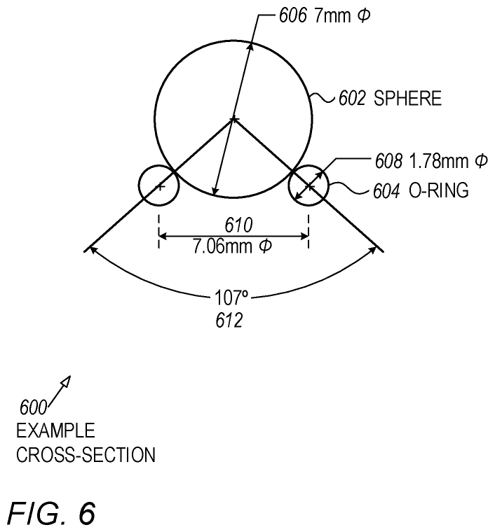

FIG. 6 is a diagram illustration of an embodiment 600 showing a sphere and O-ring arrangement. A sphere 602 may be shown in cross section with an O-ring 604. The sphere 602 may have a diameter of 7mm 606. The O-ring 604 may have a cross section diameter of 1.78 mm 608 and a circular diameter of 7.06 mm 610.

The effective angle of incidence between the sphere 602 and O-ring 604 may be 107 degrees 612. Various tests have shown that incidence angles between 105 and 100 degrees to operate very well, with angles of 90 through 120 degrees also being effective. As the angle of incidence increases, the downward force applied by fluid pressure increases. The tradeoff between adequate retraction force by a magnet verses downward sealing force has been analyzed to determine the appropriate angle of incidence.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A valve system comprising:
a magnetic plunger;
a lower plate comprising a first portion of a fluid path and a receiver for said magnetic plunger, said receiver being designed such that when said magnetic plunger rests in said receiver, fluid is prevented from flowing;
an upper plate comprising a second portion of said fluid path;
a compliant gasket mounted between said upper plate and said lower plate such that said upper plate and said lower plate form said fluid path when attached together;
an actuating magnet mounted above said upper plate and movable between an actuated position and a non-actuated position, said actuated position being where said actuating magnet is positioned to attract said magnetic plunger away from said lower plate.

2. The valve system of claim 1, said actuating magnet being an electromagnet.

3. The valve system of claim 1, said actuating magnet being a permanent magnet.

4. The valve system of claim 1 comprising a plurality of said magnetic plungers in a plurality of receivers.

5. The valve system of claim 4 comprising a first input, said fluid path connecting said first input to said plurality of receivers.

6. The valve system of claim 1, said lower plate and said upper plate being mechanically attached to each other.

7. The valve system of claim 6, said lower plate and said upper plate being ultrasonically welded to each other.

8. The valve system of claim 6, said lower plate and said upper plate being removably attached to each other.

9. The valve system of claim 8, said lower plate and said upper plate being held together by snap fit.

10. The valve system of claim 8, said lower plate and said upper plate being held together by fasteners.

11. The valve system of claim 1, said actuating magnet having a predefined movement path.

12. The valve system of claim 2, said predefined movement path being defined by a guide track.

13. The valve of claim 1, said actuating magnet being movable by manual activation by a human.

14. The valve of claim 1, said actuating magnet being movable by a controller.

15. The valve of claim 14, said controller configured to control said actuating magnet by a motor mechanically coupled to said actuating magnet.

16. The valve system of claim 1, said magnetic plunger having a disk shape.

17. The valve system of claim 16, said magnetic plunger further comprising a positioning mechanism.

18. The valve system of claim 1 said magnetic plunger having a spherical shape.

19. The valve system of claim 1, said compliant gasket being an o-ring mounted in said receiver.

20. The valve system of claim 1, said compliant gasket comprising a sealing portion and a membrane portion.

21. The valve system of claim 20, said membrane portion having a fluid side and a non-fluid side.

22. The valve system of claim 21 further comprising a mechanical nudge system.

23. The valve system of claim 22, said mechanical nudge system comprising an actuator configured to push said magnetic plunger through said membrane portion of said compliant gasket.

24. The valve system of claim 1, said compliant gasket further comprising an outlet tube.

25. The valve system of claim 24, said compliant gasket having a funnel shape.
